(19) United States
(12) Patent Application Publication
(10) Pub. No.: US 2026/0099027 A1
(43) Pub. Date: Apr. 9, 2026

(54) LENS SET AND LENS UNIT

(71) Applicant: NIDEC INSTRUMENTS CORPORATION, Nagano (JP)

(72) Inventors: Tomoaki NAKAJIMA, Nagano (JP); Tadashi KOMIYAMA, Nagano (JP)

(73) Assignee: NIDEC INSTRUMENTS CORPORATION, Nagano (JP)

(21) Appl. No.: 19/348,737

(22) Filed: Oct. 2, 2025

Related U.S. Application Data
(63) Continuation of application No. PCT/JP2024/009740, filed on Mar. 13, 2024.

(30) Foreign Application Priority Data
Apr. 3, 2023 (JP) 2023-059820

(51) Int. Cl. G02B 7/02; G02B 1/04

(52) U.S. Cl. CPC G02B 7/021; G02B 1/041; G02B 7/025

(57) ABSTRACT

A lens set includes a lens and a lens that are adjacent to each other while forming an air gap in an optical axis direction. The lens includes a flange portion. The lens includes a second flange portion and a concave portion provided on an object side of the second flange portion and accommodating the lens. An outer circumferential surface of the flange portion includes a first tapered surface that is tilted radially inward toward an image side. An inner circumferential surface of the concave portion includes a second tapered surface that is tilted radially outward toward the object side. When the lens is accommodated in the concave portion, the first tapered surface contacts the second tapered surface, whereby a position of the lens in the optical axis direction with respect to the lens and a position of a center thereof with respect to the optical axis are determined.

### CROSS-REFERENCE TO RELATED APPLICATION

This application is a continuation of PCT International Application No. PCT/JP2024/009740, filed on March 13, 2024, which claims priority under 35 U.S.C §119(a) to Japanese Patent Application No. 2023-059820, filed on April 3, 2023. Each of the above application(s) is hereby expressly incorporated by reference, in its entirety, into the present application.

### BACKGROUND

### TECHNICAL FIELD

The present invention relates to a lens set in which plural lenses are integrated, and a lens unit.

### DESCRIPTION OF RELATED ART

A lens unit that is used in an imaging apparatus mounted on an automobile or a surveillance camera is described in Patent Literature 1 (Japanese Patent Application Laid-Open No. 2021-39170). The lens unit in the same literature includes plural lenses and a lens barrel that holds the plural lenses. The plural lenses include a first lens, a second lens, a third lens, a fourth lens, a fifth lens, and a sixth lens that are arranged in this order from an object side toward an image side. The fifth lens includes a concave portion that is opened toward the object side. The fourth lens is fixed to the concave portion by being fitted to the concave portion. In this way, the fourth lens and the fifth lens are integrated to form a lens set.

In the above lens set, the concave portion has an inner circumferential surface that extends linearly in an optical axis direction, and the fourth lens has an outer circumferential surface that extends linearly in the optical axis direction. The fourth lens is press-fitted into the concave portion by a jig or the like when the lens set is assembled.

Here, the inner circumferential surface of the concave portion and the outer circumferential surface of the fourth lens extend linearly in the optical axis direction. Thus, when the fourth lens is press-fitted into the concave portion, the fourth lens may be press-fitted into the concave portion in a state where an optical axis of the fourth lens is tilted. In this case, the optical axis of the fourth lens does not coincide with an optical axis of the fifth lens. In addition, even in the case where the fourth lens is positioned in contact with the fifth lens in the optical axis direction, an air gap between the fourth lens and the fifth lens does not become a designed gap when the fourth lens is tilted with respect to the fifth lens.

The present invention provides a lens set in which, when a first lens is assembled to a second lens, a position of the first lens in an optical axis direction with respect to the second lens and a position of a center of the first lens with respect to an optical axis of the second lens are favorably determined, and a lens unit.

### SUMMARY

A lens set according to an aspect of the present invention includes a first lens and a second lens that are adjacent to each other while forming an air gap in an optical axis direction along an optical axis, in which, when, in the optical axis direction, a direction in which the first lens is located is set as a first direction, and a direction in which the second lens is located is set as a second direction, the first lens includes a first lens surface on a side of the first direction, a second lens surface on a side of the second direction, and an annular first flange portion that surrounds the first lens surface and the second lens surface, the second lens includes a third lens surface on a side of the first direction, a fourth lens surface on a side of the second direction, an annular second flange portion that surrounds the third lens surface and the fourth lens surface, and a concave portion that is provided on the side of the first direction in the second flange portion and accommodates the first lens, an outer circumferential surface of the first flange portion includes a first tapered surface that is tilted radially inward toward the second direction, an inner circumferential surface of the concave portion includes a second tapered surface that is tilted radially outward toward the first direction, and when the first lens is accommodated in the concave portion, the first tapered surface comes into contact with the second tapered surface, whereby a position of the first lens in the optical axis direction with respect to the second lens and a position of a center thereof with respect to the optical axis are determined.

According to an aspect of the present invention, since the first tapered surface of the first lens and the second tapered surface of the second lens are in contact with each other, the first lens is favorably positioned with respect to the second lens. As a result, it is possible to suppress deterioration of optical performance of the lens set.

In the present invention, the second flange portion preferably includes a hole portion that communicates between outside and a space formed between the second lens surface and the third lens surface when the first lens is accommodated in the concave portion. In this way, when the first lens is assembled to the concave portion, air in the space between the first lens and the second lens can be discharged to outside of the lens set, and thus the first lens can be easily assembled to the concave portion.

In the present invention, the first lens is preferably made of glass. In this way, even when the first lens is assembled to the concave portion, the first lens is less likely to be deformed, and thus the optical performance of the lens set is less likely to be deteriorated.

In the present invention, preferably, the second flange portion includes an annular flat surface portion that surrounds an end portion on a side of the first direction of the concave portion and faces the first direction, the outer circumferential surface of the first flange portion includes a protruding surface that protrudes to the side of the first direction from the flat surface portion when the first lens is accommodated in the concave portion, and an adhesive that fixes the first lens and the second lens is provided between the protruding surface and the flat surface portion. In this way, when the adhesive is applied, it is possible to suppress the adhesive from adhering to the first lens surface of the first lens.

In the present invention, preferably, the second flange portion includes an annular wall portion that surrounds a radially outer side of the flat surface portion and protrudes in the first direction, and the wall portion includes a groove portion that is cut out in the optical axis direction and in which the adhesive is stored. In this way, a region where the adhesive is applied is easily controlled.

In the present invention, preferably, the second lens is made of a resin, an outer circumferential surface of the second flange portion includes a D-cut surface that is formed by a plane orthogonal to a radial direction, and the groove portion is arranged at a position that does not overlap the D-cut surface in the radial direction. Here, in a case where the D-cut surface, which is formed with a gate mark, is provided to the outer circumferential surface, the wall portion of a portion provided with the D-cut surface is thinner in the radial direction of the wall portion than the wall portion of the other portion. Thus, according to this configuration, the groove portion can be provided in the portion where the wall portion is thick.

In the present invention, preferably, the second flange portion includes the hole portion that communicates between the outside and the space formed between the second lens surface and the third lens surface when the first lens is accommodated in the concave portion, the hole portion is arranged at a position that overlaps the D-cut surface in the radial direction, a single groove portion of the three groove portions is arranged at a position on an opposite side of the optical axis from the hole portion, and the three groove portions are arranged at equal angular intervals about the optical axis. In this way, when the second lens is molded, the second lens can favorably be molded.

A lens unit according to an aspect of the present invention includes: the above lens set; and a lens barrel that holds the lens set, in which an inner circumferential surface of the lens barrel includes protruding portions that are provided in a circumferential direction and are in contact with the outer circumferential surface of the second flange portion, and when the lens set is held by the lens barrel, in the circumferential direction, each of the protruding portions is in contact with the outer circumferential surface of the second flange portion at a position that does not overlap a portion where the first tapered surface and the second tapered surface are in contact with each other.

According to an aspect of the present invention, when the lens set is press-fitted to the lens barrel, it is possible to suppress stress generated on the outer circumferential surface of the second flange portion from being transmitted to the portion, where the first tapered surface and the second tapered surface are in contact with each other. In this way, it is possible to suppress occurrence of distortion of the first lens.

A lens unit according to an aspect of the present invention includes: the above lens set; and a lens barrel that holds the lens set, in which the lens set includes a third lens that is arranged on the side of the second direction of the second lens and is joined to the second lens, the third lens includes a fifth lens that is joined to the fourth lens surface, an inner circumferential surface of the lens barrel includes protruding portions that are provided in a circumferential direction and are in contact with the outer circumferential surface of the second flange portion, and when the lens set is held by the lens barrel, in the circumferential direction, each of the protruding portions is in contact with the outer circumferential surface of the second flange portion at a position that does not overlap a portion where the first tapered surface and the second tapered surface are in contact with each other and a portion where the fourth lens surface and the fifth lens surface are joined to each other.

According to the present invention, when the lens set is press-fitted to the lens barrel, it is possible to suppress the stress generated on the outer circumferential surface of the second flange portion from being transmitted to the portion, where the first tapered surface and the second tapered surface are in contact with each other, and the portion, where the fourth lens surface and the fifth lens surface are joined to each other. In this way, it is possible to suppress the occurrence of the distortion of the first lens. In addition, it is possible to suppress a joining force of the portion, where the fourth lens surface and the fifth lens surface are joined to each other, from being reduced.

### BRIEF DESCRIPTION OF THE DRAWINGS

FIG. 1 is a cross-sectional view of a lens unit to which the present invention is applied.

FIG. 2 is an exploded perspective view of the lens unit.

FIG. 3 is a perspective view of a lens set.

FIG. 4 is an exploded perspective view of the lens set.

FIG. 5 is a cross-sectional view taken along the line A-A in FIG. 3.

FIG. 6 is a perspective view of a cross section of a barrel portion.

FIG. 7 is a view illustrating the lens set and the barrel portion.

### DESCRIPTION OF THE EMBODIMENTS

According to an aspect of the present invention, since the first tapered surface of the first lens and the second tapered surface of the second lens are in contact with each other, the position of the first lens in the optical axis direction with respect to the second lens and the position of the center thereof with respect to the optical axis are determined. As a result, since the first lens is favorably positioned with respect to the second lens, it is possible to suppress the deterioration of the optical performance of the lens set.

An embodiment of the present invention will be described with reference to the drawings. In the following description, an object side is denoted by La, and an image side is denoted by Lb in an optical axis L direction in which an optical axis L extends.

### Configuration of Lens Unit

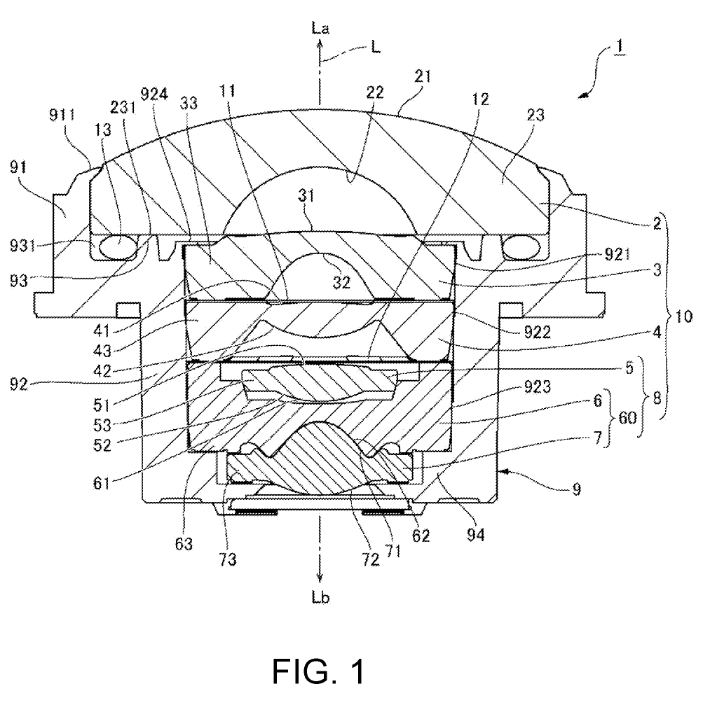

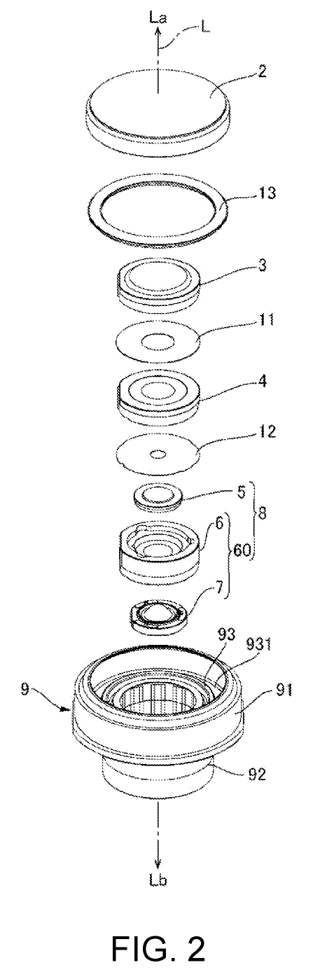

FIG. 1 is a cross-sectional view of a lens unit to which the present invention is applied. FIG. 2 is an exploded perspective view of the lens unit. A lens unit 1 according to the present embodiment is used in an imaging apparatus that is mounted on an automobile or a surveillance camera.

As illustrated in FIGS. 1 and 2, the lens unit 1 includes: a wide-angle lens 10 in which plural lenses are arranged in the optical axis L direction; and a lens barrel 9 that holds the wide-angle lens 10 therein. An imaging element is provided on the image side Lb of the lens barrel 9. The imaging element is a complementary metal-oxide semiconductor (CMOS) or the like.

The wide-angle lens 10 includes a lens 2, a lens 3, a lens 4, and a lens set 8 in an order from the object side La toward the image side Lb in the optical axis L direction. The lens set 8 includes a lens 5 (a first lens) and a lens 6 (a second lens) that are adjacent to each other while forming an air gap in the optical axis L direction. The lens set 8 also includes a lens 7 that is joined to the lens 6.

The lens unit 1 includes: an annular light-shielding sheet 11 that is arranged between the lens 3 and the lens 4; and an annular diaphragm 12 that is arranged between the lens 4 and the lens 5.

### Wide-Angle Lens

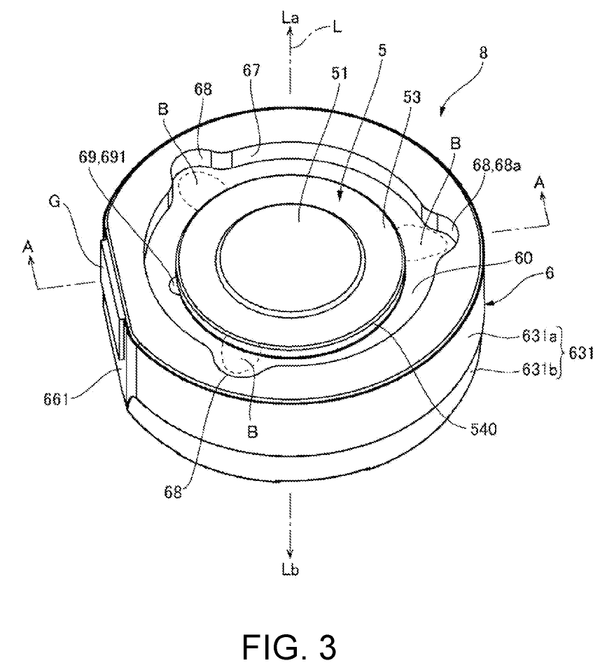

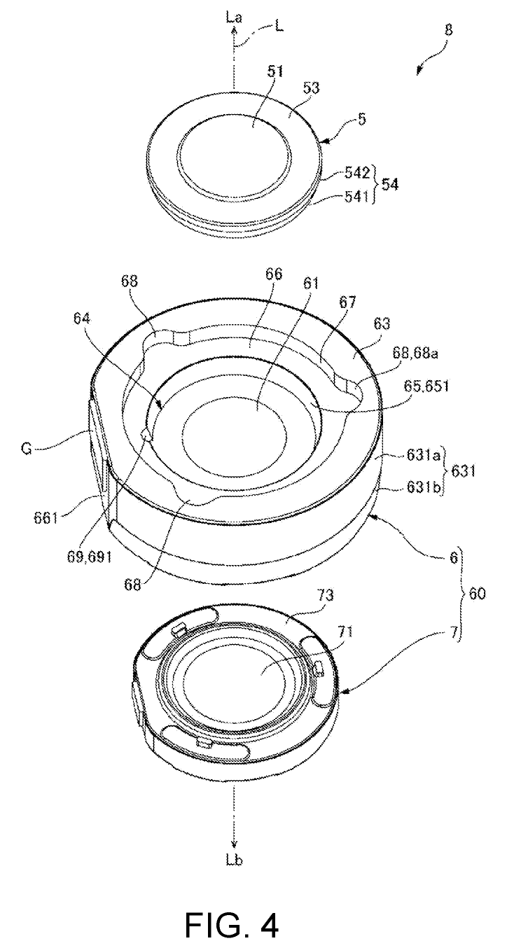

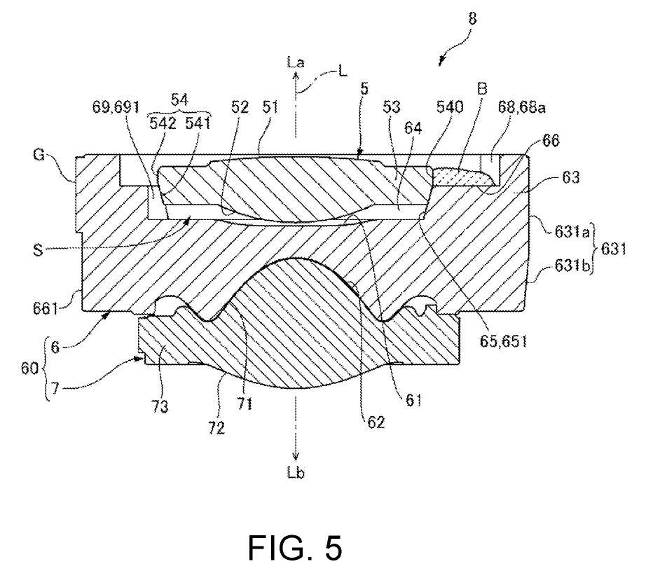

FIG. 3 is a perspective view of the lens set. FIG. 4 is an exploded perspective view of the lens set. FIG. 5 is a cross-sectional view taken along the line A-A in FIG. 3.

As illustrated in FIG. 1, the lens 2 is made of a resin or glass. The lens 2 is a meniscus lens. The lens 2 includes a lens surface 21 on the object side La, a lens surface 22 on the image side Lb, and an annular flange portion 23 that surrounds the lens surface 21 and the lens surface 22 on an outer circumferential side. The lens surface 21 has a convex surface shape that protrudes toward the object side La. The lens surface 22 has a concave surface shape that is recessed toward the object side La.

As illustrated in FIG. 1, the lens 3 is made of the resin. The lens 3 is a meniscus lens. The lens 3 includes a lens surface 31 on the object side La, a lens surface 32 on the image side Lb, and an annular flange portion 33 that surrounds the lens surface 31 and the lens surface 32 on an outer circumferential side. The lens surface 31 has a convex surface shape that protrudes toward the object side La. The lens surface 32 has a concave surface shape that is recessed toward the object side La.

As illustrated in FIG. 1, the lens 4 is made of the resin. The lens 4 includes a lens surface 41 on the object side La, a lens surface 42 on the image side Lb, and an annular flange portion 43 that surrounds the lens surface 41 and the lens surface 42 on an outer circumferential side. The lens surface 41 has a convex surface shape that protrudes toward the object side La. The lens surface 42 has a convex surface shape that protrudes toward the object side La.

As illustrated in FIGS. 3 to 5, the lens 5 is made of the glass. The lens 5 includes a lens surface 51 (a first lens surface) on the object side La, a lens surface 52 (a second lens surface) on the image side Lb, and an annular flange portion 53 (a first flange portion) that surrounds the lens surface 51 and the lens surface 52 on an outer circumferential side. The lens surface 51 has a convex surface shape that protrudes toward the object side La. The lens surface 52 has a convex surface shape that protrudes toward the object side La. An outer circumferential surface 54 of the flange portion 53 includes, in an order from the image side Lb toward the object side La: a first tapered surface 541 that is tilted radially inward toward the image side Lb; and a linear surface 542 that extends linearly in the optical axis L direction.

As illustrated in FIGS. 3 to 5, the lens 6 includes a lens surface 61 (a third lens surface) on the object side La, a lens surface 62 (a fourth lens surface) on the image side Lb, an annular flange portion 63 (a second flange portion) that surrounds the lens surface 61 and the lens surface 62 on an outer circumferential side, a concave portion 64 that is provided on the object side La of the flange portion 63 and accommodates the lens 6, and a hole portion 69. An inner circumferential surface 65 of the concave portion 64 has an annular shape. The inner circumferential surface 65 of the concave portion 64 includes a second tapered surface 651 that is tilted radially outward toward a first direction. The second tapered surface 651 opposes the first tapered surface 541 in the optical axis L direction. In the present embodiment, tilt angles of the first tapered surface 541 and the second tapered surface 651 are the same. As illustrated in FIGS. 3 and 4, the outer circumferential surface 631 of the lens 6 includes a D-cut surface 661 that is formed by a plane orthogonal to the radial direction. A gate mark G is formed on the D-cut surface 661.

The flange portion 63 includes: an annular flat surface portion 66 that surrounds an end portion on the object side La of the concave portion 64 on an outer circumferential side and faces the object side La; and an annular wall portion 67 that surrounds a radial outer side of the flat surface portion 66 and protrudes toward the object side La. The wall portion 67 includes a groove portion 68 that is cut out in the optical axis L direction and in which an adhesive B is stored. In this embodiment, the three groove portions 68 are provided. Each of the groove portions 68 also functions as a guide for an injection port of a syringe that applies the adhesive B. The adhesive B fixes the lens 5 and the lens 6. When the lens 5 is accommodated in the concave portion 64, the hole portion 69 communicates between the outside and a space S that is formed between the lens surface 52 of the lens 5 and the lens surface 61 of the lens 6. In the present embodiment, the hole portion 69 is a groove portion 691 that cuts out the inner circumferential surface 65 of the concave portion 64 in the optical axis L direction.

Here, as illustrated in FIG. 3, the groove portion 68 is arranged at a position that does not overlap the D-cut surface 661 in the radial direction. The hole portion 69 is arranged at a position that overlaps the D-cut surface 661 in the radial direction. The single groove portion 68a of the three groove portions 68 is arranged at a position on an opposite side of the optical axis L from the hole portion 69. The three groove portions 68 are arranged at equal angular intervals about the optical axis L.

As illustrated in FIGS. 3 to 5, the lens 7 includes a lens surface 71 (a fifth lens surface) on the object side La, a lens surface 72 on the image side Lb, and an annular flange portion 73 that surrounds the lens surface 71 and the lens surface 72 on an outer circumferential side. The lens surface 62 of the lens 6 and the lens surface 71 of the lens 7 are joined to each other by the adhesive. In this way, the lens 6 and the lens 7 form a cemented lens 60.

In the lens set 8, the lens 5 and the lens 6 are integrated by fitting the lens 5 to the concave portion 64. As illustrated in FIG. 5, when the lens 5 is accommodated in the concave portion 64, the first tapered surface 541 comes into contact with the second tapered surface 651, whereby a position of the lens 5 in the optical axis L direction with respect to the lens 6 and a position of a center thereof with respect to the optical axis L are determined. As a result, the centers of the lens 5 and the lens 6 coincide with each other, and the air gap between the lens 5 and the lens 6 obtains a predetermined value.

Here, as illustrated in FIGS. 3 and 5, the outer circumferential surface 54 of the flange portion 53 includes a protruding surface 540 that protrudes toward the object side La from the flat surface portion 66 when the lens 5 is accommodated in the concave portion 64. In this embodiment, the protruding surface 540 includes the linear surface 542 and a part of the first tapered surface 541. The adhesive B for fixing the lens 5 and the lens 6 is provided between the protruding surface 540 and the flat surface portion 66.

### Lens Barrel

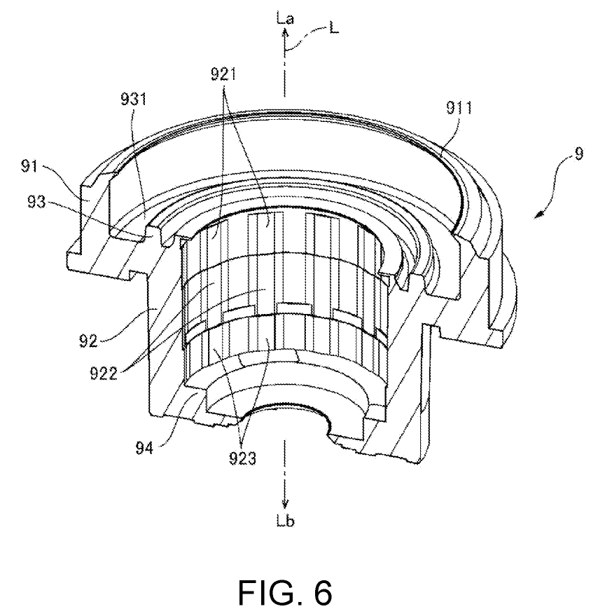

FIG. 6 is a perspective view of a cross section of a barrel portion. The lens barrel 9 is made of the resin. A material of the lens barrel 9 is crystalline plastic (polyethylene, polyamide, or polytetrafluoroethylene) having excellent weather resistance, amorphous plastic (polycarbonate or the like) having a relatively low moisture absorption property, or the like. As illustrated in FIGS. 1 and 6, the lens barrel 9 includes: a first barrel portion 91 that holds the lens 2; a second barrel portion 92 that holds the lenses 3 to 7; a contact surface portion 93 that connects the first barrel portion 91 and the second barrel portion 92; and a step portion 94 that protrudes radially inward from an inner circumferential surface of the second barrel portion 92.

The first barrel portion 91 has a cylindrical shape and surrounds the outer circumferential surface of the lens 2. A caulking portion 911 for fixing the lens 2 is provided in an end portion on the object side La of the first barrel portion 91. An inner diameter dimension of the first barrel portion 91 is slightly larger than an outer diameter dimension of the lens 2.

The contact surface portion 93 is an annular surface portion that faces the object side La. The contact surface portion 93 is in contact with a flange surface 231 of the flange portion 23 from the image side Lb. The contact surface portion 93 includes an annular groove portion 931 that is recessed toward the image side Lb. An elastic member 13 is arranged in the groove portion 931. In the present embodiment, the elastic member 13 is an O-ring.

The second barrel portion 92 has a cylindrical shape. An inner diameter of the second barrel portion 92 is slightly reduced toward the image side Lb. The second barrel portion 92 includes a first protruding portion 921, a second protruding portion 922, and a third protruding portion 923 in an order from the object side La toward the image side Lb. The plural first protruding portions 921, the plural second protruding portions 922, and the plural third protruding portions 923 are provided in the same number in the circumferential direction. A caulking portion 924 for fixing the lens 3 is provided in an end portion on the object side La of the second barrel portion 92.

The first protruding portion 921 protrudes radially inward and extends in the optical axis L direction. The first protruding portion 921 positions the lens 3 in the radial direction when the lens 3 is press-fitted into the second barrel portion 92. The second protruding portion 922 protrudes radially inward and extends in the optical axis L direction. The second protruding portion 922 positions the lens 4 in the radial direction when the lens 4 is press-fitted into the second barrel portion 92. The third protruding portion 923 protrudes radially inward and extends in the optical axis L direction. The third protruding portion 923 positions the lens set 8 in the radial direction when the lens set 8 is press-fitted into the second barrel portion 92.

The step portion 94 comes into contact with the flange portion 63 of the lens 6 from the image side Lb and thereby positions the lens set 8 in the optical axis L direction.

### Fixation of Wide-Angle Lens

The lens 3, the lens 4, and the lens set 8 are press-fitted into the second barrel portion 92 in an order from the lens set 8 on the image side Lb. The flange portion 63 of the lens 6 is in contact with the step portion 94 from the object side La. The flange portion 43 of the lens 4 is in contact with the flange portion 63 of the lens 6 from the object side La, via the diaphragm 12. The flange portion 33 of the lens 3 is in contact with the flange portion 43 of the lens 4 from the object side La via the light-shielding sheet 11.

The flange portion 33 of the lens 3 is covered with the caulking portion 924 from the object side La, and movement of the lens 3 to the object side La is thereby regulated. As a result, the lens 3, the light-shielding sheet 11, the lens 4, the diaphragm 12, and the lens set 8 are held inside the second barrel portion 92.

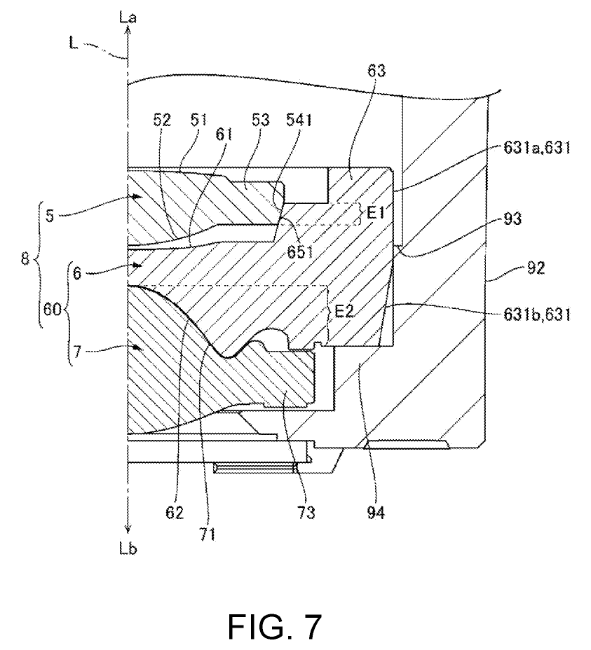

Here, FIG. 7 is a view illustrating a relationship between the lens set and the barrel portion. As illustrated in FIG. 7, the outer circumferential surface 631 of the lens 6 includes, in an order from the object side La toward the image side Lb: a first outer circumferential surface 631a that extends in parallel with the optical axis L; and a second outer circumferential surface 631b that is tilted radially inward toward the image side Lb. When the lens set 8 is held by the second barrel portion 92, the third protruding portion 923 comes into contact with the first outer circumferential surface 631a of the flange portion 63 at a position that does not overlap a portion E1 where the first tapered surface 541 and the second tapered surface 651 are in contact with each other and a portion E2 where the lens surface 62 of the lens 6 and the lens surface 71 of the lens 7 are joined to each other in the circumferential direction.

The lens 2 is press-fitted into the first barrel portion 91. More specifically, the flange portion 23 of the lens 2 is covered with the caulking portion 911 from the object side La, and movement thereof to the object side La is thereby regulated. As a result, the lens 2 is held inside the first barrel portion 91. At this time, the elastic member 13 is in close contact with the flange surface 231 of the lens 2 and the groove portion 931 in a state of being elastically deformed in the optical axis L direction.

### Operational Effects

The lens set 8 in the present embodiment includes the lens 5 and the lens 6 that are adjacent to each other while forming the air gap in the optical axis L direction. The lens 5 includes the lens surface 51 on the object side La, the lens surface 52 on the image side Lb, and the annular flange portion 53 surrounding the lens surface 51 and the lens surface 52. The lens 6 includes the lens surface 61 on the object side La, the lens surface 62 on the image side Lb, the annular flange portion 63 that surrounds the lens surface 61 and the lens surface 62, and the concave portion 64 that is provided on the object side La of the flange portion 63 and accommodates the lens 5. The outer circumferential surface 54 of the flange portion 53 includes the first tapered surface 541 that is tilted radially inward toward the image side Lb. The inner circumferential surface 65 of the concave portion 64 includes the second tapered surface 651 that is tilted radially outward toward the object side La. When the lens 5 is accommodated in the concave portion 64, the first tapered surface 541 comes into contact with the second tapered surface 651, whereby the position of the lens 5 in the optical axis L direction with respect to the lens 6 and the position of the center thereof with respect to the optical axis L are determined.

In this way, the first tapered surface 541 of the lens 5 and the second tapered surface 651 of the lens 6 are in contact with each other, and thus the lens 5 is favorably positioned with respect to the lens 6. As a result, it is possible to suppress deterioration of optical performance of the lens set 8.

The flange portion 63 includes the hole portion 69 that communicates between the outside and the space S formed between the lens surface 52 and the lens surface 61 when the lens 5 is accommodated in the concave portion 64. Accordingly, when the lens 5 is assembled to the concave portion 64, the air in the space S between the lens 5 and the lens 6 can be discharged to the outside of the lens set 8, and thus the lens 5 can be easily assembled to the concave portion 64.

The lens 5 is made of the glass. In this way, even when the lens 5 is assembled to the concave portion 64, the lens 5 is less likely to be deformed, and thus the optical performance of the lens set 8 is less likely to be deteriorated.

The flange portion 63 includes the annular flat surface portion 66 that surrounds the end portion on the object side La of the concave portion 64 on the outer circumferential side and faces the object side La. The outer circumferential surface 54 of the flange portion 53 includes the protruding surface 540 that protrudes toward the object side La from the flat surface portion 66 when the lens 5 is accommodated in the concave portion 64. The adhesive B for fixing the lens 5 and the lens 6 is provided between the protruding surface 540 and the flat surface portion 66. Accordingly, when the adhesive B is applied, it is possible to suppress the adhesive B from adhering to the lens surface 51 on the object side La of the lens 5.

The flange portion 63 includes the annular wall portion 67 that surrounds the radially outer side of the flat surface portion 66 and protrudes toward the object side La. The wall portion 67 includes the groove portion 68 that is cut out in the optical axis L direction and in which the adhesive B is stored. In this way, a region where the adhesive B is applied is easily controlled.

The lens 6 is made of the resin. The outer circumferential surface 631 of the flange portion 63 includes the D-cut surface 661 that is formed by the plane orthogonal to the radial direction. The groove portion 68 is arranged at the position that does not overlap the D-cut surface 661 in the radial direction. Here, in a case where the D-cut surface 661, which is formed with the gate mark G, is provided to the outer circumferential surface 631, the wall portion 67 of a portion provided with the D-cut surface 661 is thinner in the radial direction of the wall portion 67 than the wall portion 67 of the other portion. Thus, according to this configuration, the groove portion 68 can be provided in the portion where the wall portion 67 is thick.

The three groove portions 68 are provided. The hole portion 69 is arranged at the position that overlaps the D-cut surface 661 in the radial direction. The single groove portion 68a of the three groove portions 68 is arranged at the position on the opposite side of the optical axis L from the hole portion 69. The three groove portions 68 are arranged at the equal angular intervals about the optical axis L. Accordingly, when the lens 6 is molded, a sink mark or the like is less likely to be generated in the lens 6. Thus, the lens 6 can favorably be molded.

The lens unit 1 in the present embodiment includes the lens set 8 and the lens barrel 9 that holds the lens set 8. The lens set 8 includes the lens 7 that is arranged on the image side Lb of the lens 6 and joined to the lens 6. The lens 7 includes the lens surface 71 that is joined to the lens surface 62. An inner circumferential surface of the lens barrel 9 includes the plural third protruding portions 923 that are provided in the circumferential direction and in contact with the outer circumferential surface 631 of the flange portion 63. When the lens set 8 is held by the lens barrel 9, in the circumferential direction, the third protruding portion 923 comes into contact with the outer circumferential surface 631 of the flange portion 63 at the position that does not overlap the portion E1, where the first tapered surface 541 and the second tapered surface 651 are in contact with each other, and the portion E2, where the lens surface 62 and the lens surface 71 are joined to each other. Accordingly, when the lens set 8 is press-fitted to the lens barrel 9, it is possible to suppress stress generated on the outer circumferential surface 631 of the flange portion 63 from being transmitted to the portion E1, where the first tapered surface 541 and the second tapered surface 651 are in contact with each other, and the portion E2, where the lens surface 62 and the lens surface 71 are joined to each other. As a result, it is possible to suppress occurrence of distortion of the lens 5. In addition, it is possible to suppress a joining force of the portion E2, where the lens surface 62 and the lens surface 71 are joined to each other, from being reduced.

### Other Embodiments

The lens set may be configured that the lens corresponding to the first lens in the present invention is located on the image side Lb and that the lens corresponding to the second lens in the present invention is located on the object side La.

In the above embodiment, the lens set 8 includes the cemented lens 60. However, the lens set 8 may not include the cemented lens 60. That is, the lens set 8 may merely include the lens 5 and the lens 6.

The lens set 8 may include a lens that is arranged on the image side Lb of the lens 7 and joined to the lens 7. That is, the lens set 8 may include a cemented lens that is formed by three lenses.

The hole portion 69 is not limited to that in the above embodiment. The hole portion 69 may have any shape as long as the shape allows communication between the space S and the outside.

In the above embodiment, the protruding surface 540 is not limited to that in the above embodiment. The protruding surface 540 may have any shape as long as it is a part of the outer circumferential surface 54 and is shaped to be provided with the adhesive B.

The present technique can be configured as follows.

(1) A lens set including: a first lens and a second lens that are adjacent to each other while forming an air gap in an optical axis direction along an optical axis, in which when, in the optical axis direction, a direction in which the first lens is located is set as a first direction, and a direction in which the second lens is located is set as a second direction, the first lens includes a first lens surface on a side of the first direction, a second lens surface on a side of the second direction, and an annular first flange portion that surrounds the first lens surface and the second lens surface, the second lens includes a third lens surface on a side of the first direction, a fourth lens surface on a side of the second direction, an annular second flange portion that surrounds the third lens surface and the fourth lens surface, and a concave portion that is provided on the side of the first direction in the second flange portion and accommodates the first lens, an outer circumferential surface of the first flange portion includes a first tapered surface that is tilted radially inward toward the second direction, an inner circumferential surface of the concave portion includes a second tapered surface that is tilted radially outward toward the first direction, and when the first lens is accommodated in the concave portion, the first tapered surface comes into contact with the second tapered surface, whereby a position of the first lens in the optical axis direction with respect to the second lens and a position of a center thereof with respect to the optical axis are determined.

(2) The lens set according to (1), in which the second flange portion includes a hole portion that communicates between outside and a space formed between the second lens surface and the third lens surface when the first lens is accommodated in the concave portion.

(3) The lens set according to (1) or (2), in which the first lens is made of glass.

(4) The lens set according to any one of (1) to (3), in which the second flange portion includes an annular flat surface portion that surrounds an end portion on a side of the first direction of the concave portion and faces the first direction, the outer circumferential surface of the first flange portion includes a protruding surface that protrudes to the side of the first direction from the flat surface portion when the first lens is accommodated in the concave portion, and an adhesive that fixes the first lens and the second lens is provided between the protruding surface and the flat surface portion.

(5) The lens set according to (4), in which the second flange portion includes an annular wall portion that surrounds a radially outer side of the flat surface portion and protrudes in the first direction, and the wall portion includes a groove portion that is cut out in the optical axis direction and in which the adhesive is stored.

(6) The lens set according to (5), in which the second lens is made of a resin, an outer circumferential surface of the second flange portion includes a D-cut surface that is formed by a plane orthogonal to a radial direction, and the groove portion is arranged at a position that does not overlap the D-cut surface in the radial direction.

(7) The lens set according to (6), in which the second flange portion includes the hole portion that communicates between the outside and the space formed between the second lens surface and the third lens surface when the first lens is accommodated in the concave portion, the hole portion is arranged at a position that overlaps the D-cut surface in the radial direction, a single groove portion of the three groove portions is arranged at a position on an opposite side of the optical axis from the hole portion, and the three groove portions are arranged at equal angular intervals about the optical axis.

(8) A lens unit including: the lens set according to any one of (1) to (7); and a lens barrel that holds the lens set, in which an inner circumferential surface of the lens barrel includes protruding portions that are provided in a circumferential direction and are in contact with the outer circumferential surface of the second flange portion, and when the lens set is held by the lens barrel, in the circumferential direction, each of the protruding portions is in contact with the outer circumferential surface of the second flange portion at a position that does not overlap a portion where the first tapered surface and the second tapered surface are in contact with each other.

(9) A lens unit including: the lens set according to any one of (1) to (7); and a lens barrel that holds the lens set, in which the lens set includes a third lens that is arranged on the side of the second direction of the second lens and is joined to the second lens, the third lens includes a fifth lens that is joined to the fourth lens surface, an inner circumferential surface of the lens barrel includes protruding portions that are provided in a circumferential direction and are in contact with the outer circumferential surface of the second flange portion, and when the lens set is held by the lens barrel, in the circumferential direction, each of the protruding portions is in contact with the outer circumferential surface of the second flange portion at a position that does not overlap a portion where the first tapered surface and the second tapered surface are in contact with each other and a portion where the fourth lens surface and the fifth lens surface are joined to each other.

1. A lens set comprising:
a first lens and a second lens that are adjacent to each other while forming an air gap in an optical axis direction along an optical axis, wherein
when, in the optical axis direction, a direction in which the first lens is located is set as a first direction, and a direction in which the second lens is located is set as a second direction,
the first lens includes a first lens surface on a side of the first direction, a second lens surface on a side of the second direction, and an annular first flange portion that surrounds the first lens surface and the second lens surface,
the second lens includes a third lens surface on a side of the first direction, a fourth lens surface on a side of the second direction, an annular second flange portion that surrounds the third lens surface and the fourth lens surface, and a concave portion that is provided on the side of the first direction in the second flange portion and accommodates the first lens,
an outer circumferential surface of the first flange portion includes a first tapered surface that is tilted radially inward toward the second direction,
an inner circumferential surface of the concave portion includes a second tapered surface that is tilted radially outward toward the first direction, and
when the first lens is accommodated in the concave portion, the first tapered surface comes into contact with the second tapered surface, whereby a position of the first lens in the optical axis direction with respect to the second lens and a position of a center thereof with respect to the optical axis are determined.

2. The lens set according to claim 1, wherein
the second flange portion includes a hole portion that communicates between outside and a space formed between the second lens surface and the third lens surface when the first lens is accommodated in the concave portion.

3. The lens set according to claim 1, wherein
the first lens is made of glass.

4. The lens set according to claim 1, wherein
the second flange portion includes an annular flat surface portion that surrounds an end portion on a side of the first direction of the concave portion and faces the first direction,
the outer circumferential surface of the first flange portion includes a protruding surface that protrudes to the side of the first direction from the flat surface portion when the first lens is accommodated in the concave portion, and
an adhesive that fixes the first lens and the second lens is provided between the protruding surface and the flat surface portion.

5. The lens set according to claim 4, wherein
the second flange portion includes an annular wall portion that surrounds a radially outer side of the flat surface portion and protrudes in the first direction, and
the wall portion includes a groove portion that is cut out in the optical axis direction and in which the adhesive is stored.

6. The lens set according to claim 5, wherein
the second lens is made of a resin,
an outer circumferential surface of the second flange portion includes a D-cut surface that is formed by a plane orthogonal to a radial direction, and
the groove portion is arranged at a position that does not overlap the D-cut surface in the radial direction.

7. The lens set according to claim 6, wherein
the second flange portion includes a hole portion that communicates between outside and a space formed between the second lens surface and the third lens surface when the first lens is accommodated in the concave portion,
the groove portion is provided with three,
the hole portion is arranged at a position that overlaps the D-cut surface in the radial direction,
a single groove portion of the three groove portions is arranged at a position on an opposite side of the optical axis from the hole portion, and
the three groove portions are arranged at equal angular intervals about the optical axis.

8. A lens unit comprising:
the lens set according to claim 1; and
a lens barrel that holds the lens set, wherein
an inner circumferential surface of the lens barrel includes protruding portions that are provided in a circumferential direction and are in contact with an outer circumferential surface of the second flange portion, and
when the lens set is held by the lens barrel, in the circumferential direction, each of the protruding portions is in contact with the outer circumferential surface of the second flange portion at a position that does not overlap a portion where the first tapered surface and the second tapered surface are in contact with each other.

9. A lens unit comprising:
the lens set according to claim 1 ; and
a lens barrel that holds the lens set, wherein
the lens set includes a third lens that is arranged on the side of the second direction of the second lens and is joined to the second lens,
the third lens includes a fifth lens that is joined to the fourth lens surface,
an inner circumferential surface of the lens barrel includes protruding portions that are provided in a circumferential direction and are in contact with an outer circumferential surface of the second flange portion, and
when the lens set is held by the lens barrel, in the circumferential direction, each of the protruding portions is in contact with the outer circumferential surface of the second flange portion at a position that does not overlap a portion where the first tapered surface and the second tapered surface are in contact with each other and a portion where the fourth lens surface and the fifth lens surface are joined to each other.
